(19) United States
(12) Patent Application Publication
(10) Pub. No.: US 2012/0008181 A1
(43) Pub. Date: Jan. 12, 2012

(54) Holographic Image Display Systems

(76) Inventors: Adrian J. Cable, Cambridge (GB); Gareth J. McCaughan, Cambridge (GB)

(21) Appl. No.: 13/256,673

(22) PCT Filed: Mar. 25, 2010
(86) PCT No.: PCT/GB10/50503

§ 371 Date: Sep. 15, 2011

(30) Foreign Application Priority Data
Mar. 27, 2009 (GB) 0905259.8

(51) Int. Cl. G03H 1/08

(52) U.S. Cl. 359/9

(57) ABSTRACT

We describe a method of determining an aberration correction for a holographic image display system using a spatial light modulator (SLM) to display a hologram. Embodiments of the invention measure the corrections needed for a particular projection system, using the same system SLM as used to generate the images to provide wavefront-sensing holograms. The projector's projection optics are used to provide the wavefront sensor and there is no need for lenslets. Embodiments of the invention use a plurality of successive holograms directing light from differently-located patches on the hologram into the image.

### CROSS REFERENCE TO RELATED APPLICATION

This application claims priority to PCT Application No. PCT/GB2010/050503 entitled “Holographic Image Display Systems” and filed Mar. 25, 2010, which itself claims priority to Great Britain Patent Application No. GB0905259.8 filed Mar. 27, 2009. The entirety of each of the aforementioned applications is incorporated herein by reference for all purposes.

### BACKGROUND OF THE INVENTION

This invention relates to methods, apparatus and computer program code for aberration measurement and correction in holographic image projection systems, and to aberration-corrected holographic image projection systems.

We have previously described techniques for displaying an image holographically—see, for example, WO 2005/059660 (Noise Suppression Using One Step Phase Retrieval), WO 2006/134398 (Hardware for OSPR), WO 2007/031797 (Adaptive Noise Cancellation Techniques), WO 2007/110668 (Lens Encoding), WO 2007/141567 (Colour Image Display), and WO 2008/120015 (Head Up Displays), and PCT/GB2008/051129 (Diffuser). These are all hereby incorporated by reference in their entirety.

It is desirable to correct for aberrations in a holographic image display system, to improve the quality of the images produced. It is known to employ a Shack-Hartmann sensor for measuring the phase of a wavefront, but to employ such a sensor in a holographic image display system would generally require modification of the system, which is undesirable and would not give an accurate measurement of a wavefront in an unmodified system.

Background prior art relating to wavefront sensing can be found in the following documents: GB2449359A, U.S. Pat. No. 7,268,937, U.S. Pat. No. 7,495,200, Wang et al. “Design and Optimization of Programmable Lens Array for Adaptive Optics”, 2007, Proc SPIE, Vol 6414, pages 64140K, pages 1-9; Neil et al. “Closed-loop Aberration Correction by use of a Modal Zernike wavefront Sensor”, 2000, Optics Letters, Vol 25, No 15, pages 1083-85.

There is a need for improves techniques for measuring and correcting for aberrations in a holographic image display system, in particular which can be used without substantial modification of the optics of the system.

### BRIEF DESCRIPTION OF THE DRAWINGS

These and other aspects of the invention will now be further described, by way of example only, with reference to the accompanying Figures in which:

FIG. 1 shows a simple example of a holographic image display system in conjunction with apparatus for calibrating the system according to an embodiment of the invention;

FIG. 2 shows an example optical configuration of a preferred implementation of a holographic image display system in conjunction with apparatus for calibrating the system according to an embodiment of the invention;

FIGS. 3a to 3d show an example of a holographic image display system without aberration correction illustrating, respectively, a block diagram of a hologram data calculation system, operations performed within the hardware block of the hologram data calculation system, energy spectra of a sample image before and after multiplication by a random phase matrix, and an example of a hologram data calculation system with parallel quantisers for the simultaneous generation of two sub-frames from real and imaginary components of complex holographic sub-frame data;

FIGS. 4a and 4b show, respectively, an outline block diagram of an adaptive OSPR-type system, and details of an example implementation of the system;

FIG. 5 shows, schematically, a procedure for constructing a wavefront sensing hologram according to an embodiment of the invention, and the resulting projected image (replay field);

FIGS. 6a and 6b show, respectively, diagrammatically, a procedure for correcting aberrations according to an embodiment of the invention, and examples of real data corresponding to the procedure of FIG. 6a;

FIG. 7 shows a flow diagram of a procedure corresponding to that diagrammatically illustrated in FIG. 6;

FIG. 8 illustrates a variant of the procedure of FIG. 3d implemented by a holographic image projection system configured to be used in a method of correcting aberrations according to an embodiment of the invention; and

FIG. 9 shows a block diagram of a holographic image projection system configured for use with a method according to an embodiment of the invention.

### BRIEF SUMMARY OF THE INVENTION

This invention relates to methods, apparatus and computer program code for aberration measurement and correction in holographic image projection systems, and to aberration-corrected holographic image projection systems.

According to a first aspect of the invention there is therefore provided method of determining an aberration correction for a holographic image display system, the system comprising: a spatial light modulator (SLM) to display a hologram; at least one coherent light source configured to illuminate said SLM; and projection optics to project an image formed by said illuminated, displayed hologram onto an image plane; the method comprising: displaying a wavefront sensing hologram on said SLM, said wavefront sensing hologram comprising a hologram having first and second spatial portions on said SLM, said first spatial portion comprising a patch of said hologram configured to direct light towards a target spot position in said image plane, said second spatial portion comprising a remainder of said hologram apart from said first spatial portion, said second spatial portion of said hologram being configured to direct light away from said target spot position in said image plane; measuring a position of a spot in said image plane formed by illuminating said wavefront sensing hologram with said coherent light source; determining a gradient of a phase aberration correction for said holographic image display system, to be applied at a position of said patch on said SLM, from a difference between said measured position of said spot and said target spot position; repeating said displaying, measuring and determining for a plurality of different said wavefront sensing holograms having a plurality of different spatial positions of said patch; and using said determined gradients of phase aberration correction to map phase aberration corrections for said holographic image display system.

Embodiments of the method correct for imperfections in the optics such as tilt of an optical component, off-axis positioning of a component and the like. The primary sources of aberration which are corrected comprise optical components which are in an optical path between the coherent light source and the SLM. The phase-only nature of the holographic image display system enables the image to be corrected by adjusting the hologram displayed on the SLM, in particular by multiplying by a conjugate of the phase errors introduced by aberration.

In embodiments the patches of a set of wavefront sensing holograms may define a grid or array of positions over the SLM. Thus the map of phase aberration corrections may define corresponding phase corrections to be applied to reduce variations in phase over the SLM, in effect to flatten out phase distortions. In embodiments the map of phase aberration corrections may be defined by a model to which the corrections are fitted, for example a polynomial model, conveniently expressed in terms of Zernike polynomials or Seidel functions (which are convenient because these correspond to common types of optical aberrations such as defocus, coma, spherical aberration, astigmatism and the like). Although such a polynomial function may have an undetermined constant offset, this phase offset is not discernible by the human eye.

In some preferred implementations the patch on a wavefront sensing hologram is configured to define a phase ramp (that is, phases that vary linearly over the extent of the patch), albeit this may be quantised by the ability of the SLM to display such a ramp. This moves the target spot position away from the zero order spot (irrespective of whether a binary phase or multiphase SLM is employed), thus improving signal-to-noise ratio of the measurement of displayed spot position. Preferably the second portion of the hologram, in embodiments the remainder of the hologram apart from the patch, is configured to direct light generally towards a boundary of the image plane, for example towards one or more edges and/or corners of the image plane, again to help to improve signal-to-noise ratio.

The skilled person will understand that although reference is made to an image plane—that is a plane in which the image can appear—embodiments of the holographic image display system are substantially focus-free so that an image may be formed at a (very) wide range of distances from the display system. Conveniently the position of a spot in an image plane may be measured by a camera directed at a screen on which an image is formed, for convenience with the holographic display system on one side of the (light-transmissive) screen and a (digital) camera on the same or the other side of the screen. It will be appreciated, however, that theoretically the position of a spot in an image plane may be measured by measuring the position of a spot on a curved surface, although this is practically undesirable because of the additional, unnecessary complexity; or by dispensing with the screen and projecting directly into the camera lens, effectively making the plane in which the camera sensor lies into an image plane.

Embodiments of the method map displacement in spot position to average phase gradient in one or both of two orthogonal directions at the spatial position of the patch on the SLM. With idealized projection and measurement optics, the average phase gradient is proportional to the difference between predicted and actual spot position, and the constant of proportionality can be calculated theoretically. In practice distortion in the projection optics, camera and the like means that it is preferable to calibrate the phase mapping. This may be performed by using most or all of the spatial light modulator to place a spot at a desired target position, the nominal measured position of the spot then determining the average phase gradient for most or all of the SLM. This process may be repeated, one at a time, for an array or grid of spots, to determine a calibration between displacement and average phase gradient.

Such spots need not be displayed sequentially and, in embodiments, a plurality of difference phase gradients may be superposed to display a plurality of spots simultaneously. To some extent the practicality of this depends upon how well separated the spots are in the image plane. Thus the calibration spots may be displayed sequentially, altogether, or using a combination of these two approaches. Similarly it is not necessary for a regular grid of spots to be displayed—an irregular grid or random arrangement of spots may be employed. Preferably, however, the spots extend in two dimensions and span a region where the wavefront sensing spots are likely to be displayed, for example extending over at least half the extent of the image plane in each of two orthogonal directions. The skilled person will further appreciate that it is not necessary to employ spots which extend over a two dimensional region of the image plane—just two spots will suffice to provide a measurement of scale which may be used to approximately calibrate a phase mapping, if the projection and measurement optics are close enough to ideal.

Preferred embodiments of the method also compensate for variation in intensity of the illumination of the SLM over a patch. Broadly speaking the determined gradient of phase aberration correction for a patch is weighted dependent on the spatial variation in illumination intensity over the patch (for example, dependent on intensity or, perhaps preferably, on a function of intensity squared) when fitting to the model of phase aberration corrections which defines the map of aberration corrections (normalising for intensity over the patch). In embodiments this is conveniently performed by measuring an intensity of a spot projected by a patch of a wavefront sensing hologram (using the camera, optionally with a control loop to control the image display system to control the spot brightness to inhibit saturation of the camera sensor).

In practice, the spots displayed by an uncorrected holographic image display system may be large and noisy and difficult to locate precisely. In preferred embodiments therefore, two (or more) iterations of the approach are employed, a first iteration in which an approximate map of phase aberration corrections is determined, and then a second (and optionally subsequent) iteration when the approximate phase correction is applied and a second set of wavefront sensing holograms is displayed to determine an improved map of phase aberration corrections. Thus when displaying the second set of wavefront sensing holograms the phase values for display on the SLM are corrected using the first map of phase aberration corrections prior to display on the SLM (and in a quantised phase SLM, preferably prior to quantisation). In embodiments the patches on the second set of wavefront sensing holograms may have a smaller spatial dimension than those on the first set of wavefront sensing holograms, to produce a higher resolution map. In embodiments, the initial map of phase aberration corrections applied may be relatively crude. For example, depending on the computational resources available, the coefficients of a polynomial expansion model representing the map of phase aberration corrections may be rounded, say to the nearest integer, and the rounded values used to index a library of pre-calculated wavefront maps to be applied to provide the approximate correction. Optionally the calibration of phase mapping described above may also be performed a second (or further) time prior to determining the second map of the phase aberration corrections.

In preferred embodiments the measurement of a spot position comprises determining the centroid of a spot. In preferred embodiments of the method an OSPR-type approach (see below) is employed, in which a plurality of versions of each wavefront sensing hologram is displayed in rapid succession, each version having a patch with a different pattern of pixel phase delay values on the SLM, but each version being configured to direct light towards substantially the same target spot position. Then the position of a spot in the image plane may be determined either by allowing the camera to form a time-averaged image of the spot, the position of which is then measured, or by measuring separate positions of the spot for each version of a wavefront sensing hologram then afterwards averaging these positions. If the position of a spot is measured by measuring the position of a centroid of the spot, these two approaches are equivalent.

In embodiments of the method the first spatial portion of the hologram on the SLM may be arranged to direct light towards a plurality of target spot positions rather than towards just a single target spot position, in particular by providing a plurality of patches in the first spatial portion of the hologram on the SLM. In this way multiple patches may be measured simultaneously, although again the practicality of this depends upon the separation of the actually displayed spots—for example, this may be more practical in a second rather than a first iteration of mapping of phase aberration correction.

In embodiments of the method the mapping of phase aberration corrections may be configured to take account of field dependent aberration in the holographic image display system. To achieve this, broadly speaking embodiments of the method may measure aberrations at different points in the image plane and then correct for these, for example by determining an average gradient of phase aberration correction at a fiducial location in the image plane, for example the middle of the image plane. In embodiments this may be performed by determining a set of gradients of phase aberration correction for a given spatial position of a patch, each of the gradients of phase aberration correction for the patch corresponding to a different target spot position in the image plane. The displacements of the measured spot positions from the target spot positions may then be employed to determine an average phase error gradient (for a location in the image plane). This may then be used for mapping the phase aberration corrections as previously described. This approach may be employed additionally or alternatively to the above described approach of calibrating the phase mapping by projecting a grid of spots. In a similar manner to that previously described, holograms for the set of target spot positions for a patch may be displayed either sequentially or simultaneously (superposed) or using a combination of both these approaches.

The invention also provides a method of displaying an image holographically using a holographic image display system corrected as described above. In a colour display system preferably a separate correction is determined and applied at each separate wavelength of the multiple, typically 3, different laser wavelengths employed.

The invention also provides a holographic image display system configured to implement a method as described above, in particular including means for driving the SLM to display a wavefront sensing hologram including a patch configured to direct light towards a target spot position in the image plane, and preferably to direct a remainder of the light away from the target spot. Preferably such a system also includes non-volatile memory to store a map of phase aberration corrections to be applied when displaying a wavefront sensing hologram, to facilitate multiple iterations of correction.

The invention also provides a holographic image display system corrected for aberrations determined as described above.

Thus in a further aspect the invention provides a holographic image display system corrected for optical aberrations, the system comprising: a spatial light modulator (SLM) to display a hologram; at least one coherent light source configured to illuminate said SLM; projection optics to project a holographically generated two-dimensional image, said projection optics being configured to form, at an intermediate image surface, an intermediate two-dimensional image corresponding to said holographically generated image; a diffuser located at said intermediate image surface; a processor having an output for driving said SLM with hologram data to display an image; and non-volatile memory storing a map of phase aberration corrections to be applied to said hologram displayed by said SLM when projecting said image to correct for optical aberrations of said holographic image display system.

The skilled person will appreciate that the coherent light source need only be sufficiently coherent to be able to display a hologram. Thus satisfactory, albeit inferior, holograms can be displayed using a light emitting diode rather than a laser. In embodiments of the holographic image display system the diffuser can improve perceived image quality by reducing speckle, but can also introduce phase aberrations. Thus the above described techniques can be particularly advantageous in such a system. In embodiments the diffuser comprises a pixellated, quantised phase diffuser. Optionally the diffuser may be mechanically coupled to an actuator configured to dither the diffuser, in which case the phase aberration corrections may be mapped with or without the dither applied.

Although preferred embodiments of the invention are able to work with a substantially unmodified holographic image display system (apart from a facility to display a wavefront sensing hologram as described above), some advantages may be obtained by, for example, using a mechanical mask to block light from a hologram in a holographic image display system except where the hologram comprises a patch configured to direct light towards a target spot position, for example a patch defining a phase ramp.

Thus in a further aspect there is provided method of determining an aberration correction for a holographic image display system, the method comprising: displaying a wavefront sensing hologram using said holographic image display system, said wavefront sensing hologram comprising at least one patch configured to direct light towards a target spot position in an image plane of said holographic image display system; measuring a position of a spot in said image plane formed by said holographic image display system; determining a gradient of a phase aberration correction for said holographic image display system to be applied at a position of said patch on said hologram from a difference between said measured position of said spot and said target spot position; repeating said displaying, measuring and determining for a plurality of different said wavefront sensing holograms having a plurality of different spatial positions of said patch; and using said determined gradients of phase aberration correction to map phase aberration corrections for said holographic image display system.

The invention also provides processor control code to implement the above-described methods, in particular on a data carrier such as a disk, CD- or DVD-ROM, programmed memory such as read-only memory (Firmware). Code (and/or data) to implement embodiments of the invention may comprise, for example, source, object or executable code in a conventional programming language (interpreted or compiled) such as C, or assembly code, or code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

As previously mentioned, in preferred embodiments of the above described systems and methods preferably an OSPR-type procedure is employed to display the wavefront sensing hologram. Thus in preferred embodiments a single displayed image or image frame is generated using a plurality of temporal holographic subframes displayed in rapid succession such that the corresponding images average in an observer's eye to give the impression of a single, noise-reduced displayed image.

Thus, broadly speaking, embodiments of the invention measure the corrections needed for a particular projection system, using that system's SLM (the one already used to generate images) to provide wavefront-sensing holograms. This simplifies the system, makes the measurement process non-invasive, and arranges that what is measured is substantially the same thing as what is needed for correction. This a significant benefit. In broad terms the nature of the wavefront sensor is Shack-Hartmann-like, but with no need for the lenslets because we use the projector's projection optics instead. In embodiments successive spatial portions of the SLM are measured successively. Embodiments of the invention use a plurality of successive holograms directing light from differently-located patches on the hologram into the image.

### DETAILED DESCRIPTION

This invention relates to methods, apparatus and computer program code for aberration measurement and correction in holographic image projection systems, and to aberration-corrected holographic image projection systems.

We will describe a way of using the phase-modulating element in a diffractive, holographic projector to measure the aberrations present in the projector in such a way as to make it easy to correct for them. The approach measures the wavefront directly, but without requiring the introduction of any optical elements not already present in the system—the measurement can be carried out with an unmodified projector. In broad terms the technique identifies what happens to light incident on small patches of the SLM, and exploits the fact that average phase gradient there corresponds to a position offset in the resulting image.

To aid understanding of the invention we first describe some preferred implementations of holographic image display systems with which the calibration techniques we describe may be used.

### Hologram Generation

We will describe applications of embodiments of the invention to an OSPR-type holographic image display system, and we therefore describe examples of such systems below. The calibration techniques themselves may also advantageously employ an OSPR-type (wavefront sensing) hologram generation procedure. However applications of embodiments of the invention are not restricted to this type a hologram generation procedure and may be employed with holographic image display systems employing other types of hologram generation procedure, for example: a Gerchberg-Saxton procedure (R. W. Gerchberg and W. O. Saxton, “A practical algorithm for the determination of phase from image and diffraction plane pictures” Optik 35, 237-246 (1972)) or a variant thereof, Direct Binary Search (M. A. Seldowitz, J. P. Allebach and D. W. Sweeney, “Synthesis of digital holograms by direct binary search” Appl. Opt. 26, 2788-2798 (1987)), simulated annealing (see, for example, M. P. Dames, R. J. Dowling, P. McKee, and D. Wood, “Efficient optical elements to generate intensity weighted spot arrays: design and fabrication,” Appl. Opt. 30, 2685-2691 (1991)), or a POCS (Projection Onto Constrained Sets) procedure (see, for example, C.-H. Wu, C.-L. Chen, and M. A. Fiddy, “Iterative procedure for improved computer-generated-hologram reconstruction,” Appl. Opt. 32, 5135-(1993)).

### Optical System

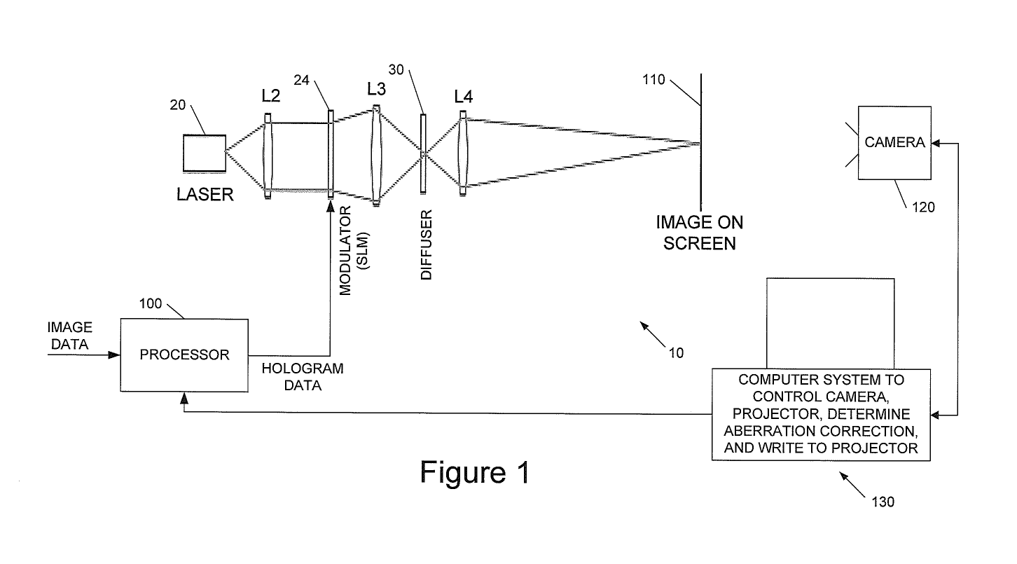

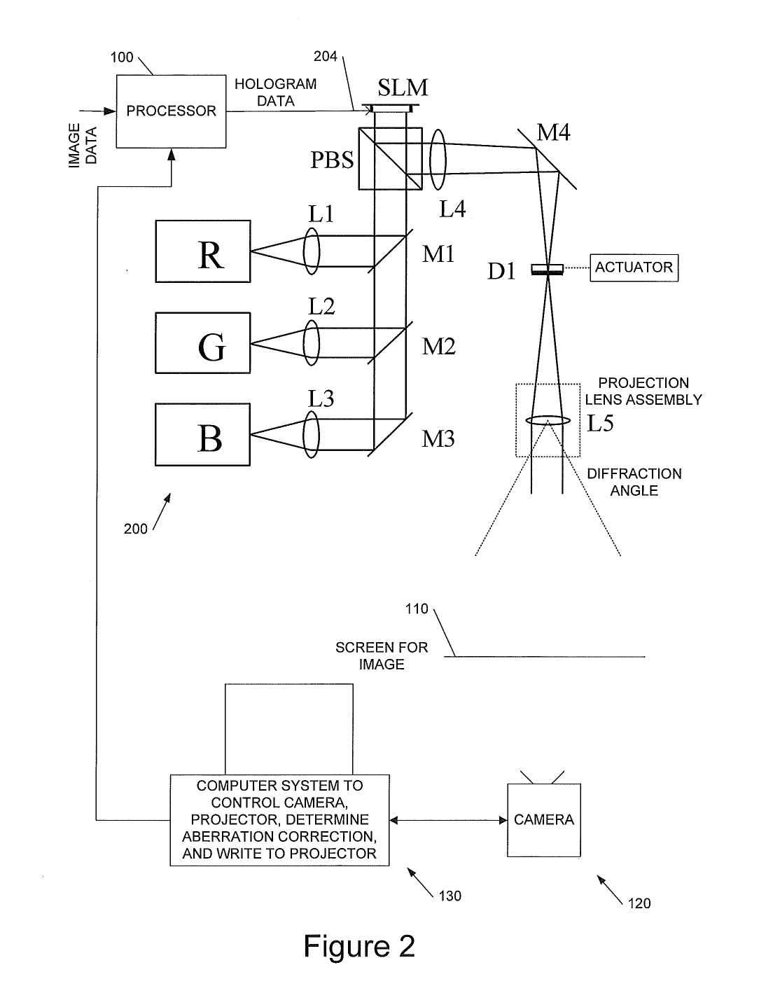

FIG. 1 shows a simple example of a holographic image projection system 10. This comprises a laser diode 20 which provides substantially collimated light to a spatial light modulator (SLM) 24, via a beam expansion lens L₂ so that the light covers the modulator (the output of the laser may include an output lens L₁ (not shown) so that L₁ and L₂ form a beam-expansion pair). The light is phase modulated by a hologram displayed on the SLM and provided to a demagnifying optical system 26, as illustrated comprising a pair of lenses (L₃, L₄) with respective focal lengths f₃, f₄, f₄<f₃, spaced apart at distance f₃+f₄, in effect forming a (demagnifying) telescope. Optical system 26 increases the size of the projected holographic image (replay field R) by diverging the light forming the displayed image, effectively reducing the pixel size of the modulator and thus increasing the diffraction angle. The beam is parallel and substantially collimated (all rays representing the same pixel are parallel); however the rays from L4 diverge according to the diffraction angle of the system (as schematically shown in FIG. 2). In embodiments a diffuser 30 (discussed below) is included at an intermediate image plane between L₃ and L₄. In some arrangements, for example a head-up display, L3 and L4 may be omitted. A spatial filter may be included to filter out a zero order undiffracted spot or a repeated first order (conjugate) image, where present. A processor 100 converts input image data into hologram data for display on the SLM.

FIG. 1 further illustrates apparatus used for aberration correction of holographic image projection system 10, described further below. This additional apparatus comprises a screen 110 onto which is projected an image formed by the hologram on the SLM 24, and a digital camera 120 to capture this image. The camera 120 is coupled to a computer system 130 to control the holographic image projection system to display wavefront sensing holograms, to control the camera to capture corresponding displayed images, to perform aberration correction calculations, and to write aberration correction data to the projection system, as described further later.

FIG. 2 shows an example optical layout for a more practical holographic image projection system 200. In the full colour holographic image projector of FIG. 2 there are red R, green G, and blue B lasers. The system also includes the following additional elements:
SLM is the hologram SLM (spatial light modulator).
L1, L2 and L3 are collimation lenses for the R, G and B lasers respectively (optional, depending upon the laser output).
M1, M2 and M3 are corresponding dichroic minors.
PBS (Polarising Beam Splitter) transmits the incident illumination to the SLM. Diffracted light produced by the SLM—naturally rotated (with a liquid crystal SLM) in polarisation by 90 degrees—is then reflected by the PBS towards L4.
Mirror M4 folds the optical path.
Lenses L4 and L5 form an output telescope (demagnifying optics), as with holographic projectors we have previously described. The output projection angle is proportional to the ratio of the focal length of L4 to that of L5. In embodiments L4 may be encoded into the hologram(s) on the SLM, for example using the techniques we have described in WO2007/110668, and/or output lens L5 may be replaced by a group of projection lenses. In embodiments L5 may comprise a wide-angle or fisheye lens, mounted for translation perpendicular to the output optical axis (left-right in FIG. 2), to enable configuration of the output optical system as an off-axis system for table-down projection.
D1 is a piezoelectrically-actuated diffuser located at intermediate image plane to reduce speckle, as we have described, for example in GB0800167.9. Moving the diffuser rapidly, preferably in two orthogonal directions to remove streaking, generates random phases on a length scale that is smaller and/or a time scale that is faster than the projected image pixel.

A processor 100 acts as a system controller and performs signal processing in either dedicated hardware, or in software, or in a combination of the two, as described further below. Thus controller 100 inputs image data and provides hologram data 204 to the SLM.

In embodiments the SLM may be a liquid crystal device. Alternatively, other SLM technologies to effect phase modulation may be employed, such as a pixellated MEMS-based piston actuator device.

Again, FIG. 2 also shows the additional apparatus employed for aberration calibration/correction (like elements to FIG. 1 are indicated by like reference numerals).

In more detail, an image is formed in the intermediate image plane, on the diffuser. The diffuser scrambles the phase of the light incident on it, and moves around rapidly so that this phase-scrambling averages out over time; in effect, “after” the diffuser the system is incoherent rather than coherent. Then the final projection lens puts a larger image of the image on the diffuser further out, in the final image plane outside the projector.

Ideally, all optical paths from the laser, via any point on the SLM, to a given (intermediate) image point, would have the same optical length (=length weighted by refractive index=total phase change). In this case, setting all SLM pixels to the same phase would produce a perfect diffraction-limited spot at the zero-order position in the intermediate image plane, and in general the image would be the convolution of a diffraction-limited spot with the Fourier transform of the phase field on the SLM.

In practice, this is not so (and may even be deliberately not so, for example to simplify the design of the lenses). Deviations from this ideal situation give rise to aberrations which we wish to correct.

For any point on the SLM and any point in the intermediate image plane, there is a unique optical path from the laser to that point in the intermediate image plane passing through that point on the SLM. So, for any point in the intermediate image plane, there is an “aberration field” recording the deviations from constancy of the optical lengths of the paths (or, equivalently, the phases of light traversing the paths) to that point via each point on the SLM.

The aberration field is usually approximately independent of which point in the image plane is chosen. When this is not true, we speak of “field-dependent aberration” (discussed in more detail later). Correcting for field-dependent aberration is problematical and it is preferable to aim to design the optical systems so as to reduce this as much a practical. For most of the techniques described later we assume that the aberrations are not field-dependent.

In general, each colour channel will exhibit different aberrations. Different colour channels involve different optical elements, and unless the common optical elements are perfectly non-dispersive they too will affect each colour differently. For the techniques described later we will consider one channel at a time.

### OSPR

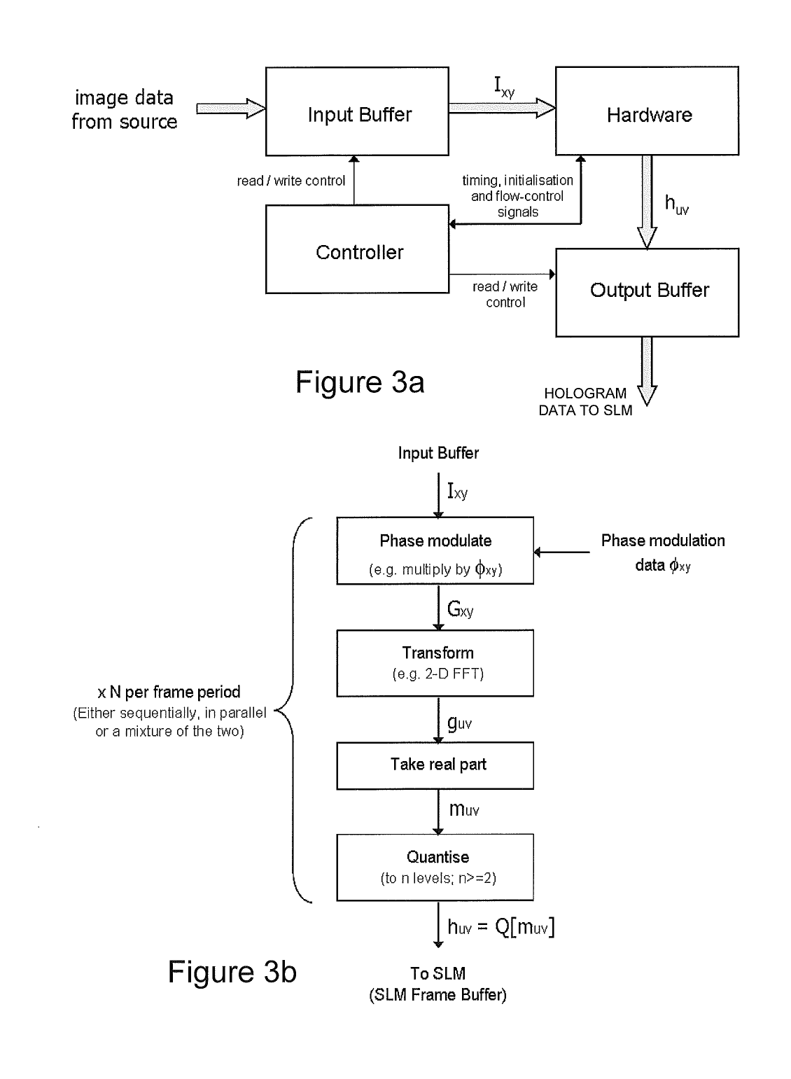

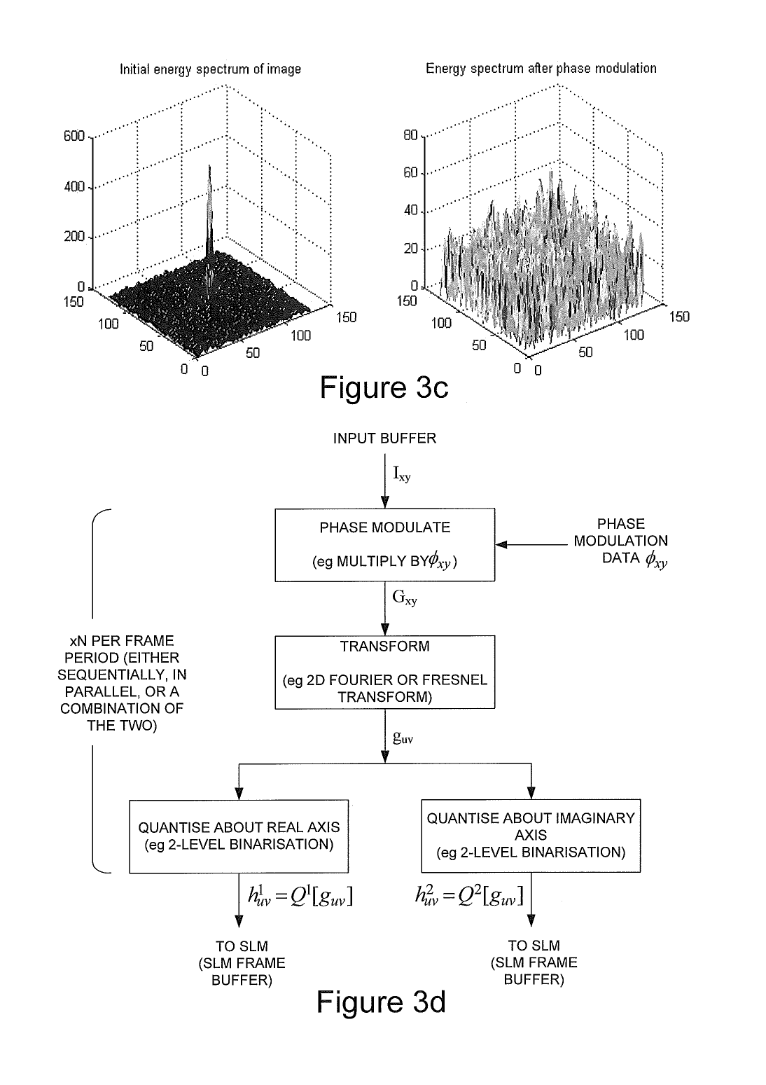

To aid in understanding the operation of embodiments of the invention we will first describe an example of a holographic image display system without aberration correction, with reference to FIGS. 3a to 3d.

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram, each of which spatially overlaps in the replay field (in embodiments each has the spatial extent of the displayed image).

Each sub-frame when viewed individually would appear relatively noisy because noise is added, for example by phase quantisation by the holographic transform of the image data. However when viewed in rapid succession the replay field images average together in the eye of a viewer to give the impression of a low noise image. The noise in successive temporal subframes may either be pseudo-random (substantially independent) or the noise in a subframe may be dependent on the noise in one or more earlier subframes, with the aim of at least partially cancelling this out, or a combination may be employed. Such a system can provide a visually high quality display even though each sub-frame, were it to be viewed separately, would appear relatively noisy.

The procedure is a method of generating, for each still or video frame I=I_{xy}, sets of N binary-phase holograms h⁽¹⁾ . . . h^{(N)}. In embodiments such sets of holograms may form replay fields that exhibit mutually independent additive noise. An example is shown below:

1. Let G_{xy}⁽ⁿ⁾=I_{xy} exp(jφ_{xy}⁽ⁿ⁾) where φ_{xy}⁽ⁿ⁾ is uniformly distributed between 0 and 2π for 1≦n≦N/2 and 1≦x, y≦m
2. Let gᵤᵥ⁽ⁿ⁾=F⁻¹[G_{xy}⁽ⁿ⁾] where F⁻¹ represents the two-dimensional inverse Fourier transform operator, for 1≦n≦N/2
3. Let mᵤᵥ⁽ⁿ⁾= [symbol] {gᵤᵥ⁽ⁿ⁾} for 1≦n≦N/2
4. Let mᵤᵥ^{(n+N/2)}=ℑ{gᵤᵥ⁽ⁿ⁾} for 1≦n≦N/2

### 5. Let

$${h}_{uv}^{( n )} = \{ \begin{matrix}- 1 if {m}_{uv}^{( n )} < {Q}^{( n )} \\ + 1 if {m}_{uv}^{( n )} \geq {Q}^{( n )}\end{matrix}$$

where Q⁽ⁿ⁾=median(mᵤᵥ⁽ⁿ⁾) and 1≦n≦N.

Step 1 forms N targets G_{xy}⁽ⁿ⁾ equal to the amplitude of the supplied intensity target I_{xy}, but with independent identically-distributed (i.i.d.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. The median value of mᵤᵥ⁽ⁿ⁾ may be assumed to be zero with minimal effect on perceived image quality.

FIG. 3a, from our WO2006/134398, shows a block diagram of a hologram data calculation system configured to implement this procedure. The input to the system is preferably image data from a source such as a computer, although other sources are equally applicable. The input data is temporarily stored in one or more input buffer, with control signals for this process being supplied from one or more controller units within the system. The input (and output) buffers preferably comprise dual-port memory such that data may be written into the buffer and read out from the buffer simultaneously. The control signals comprise timing, initialisation and flow-control information and preferably ensure that one or more holographic sub-frames are produced and sent to the SLM per video frame period.

The output from the input comprises an image frame, labelled I, and this becomes the input to a hardware block (although in other embodiments some or all of the processing may be performed in software). The hardware block performs a series of operations on each of the aforementioned image frames, I, and for each one produces one or more holographic sub-frames, h, which are sent to one or more output buffer. The sub-frames are supplied from the output buffer to a display device, such as a SLM, optionally via a driver chip.

FIG. 3b shows details of the hardware block of FIG. 3a; this comprises a set of elements designed to generate one or more holographic sub-frames for each image frame that is supplied to the block. Preferably one image frame, I_{xy}, is supplied one or more times per video frame period as an input. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block is to redistribute the energy of the input frame in the spatial-frequency domain, such that improvements in final image quality are obtained after performing later operations. FIG. 3c shows an example of how the energy of a sample image is distributed before and after a phase-modulation stage in which a pseudo-random phase distribution is used. It can be seen that modulating an image by such a phase distribution has the effect of redistributing the energy more evenly throughout the spatial-frequency domain. The skilled person will appreciate that there are many ways in which pseudo-random binary-phase modulation data may be generated (for example, a shift register with feedback).

The quantisation block takes complex hologram data, which is produced as the output of the preceding space-frequency transform block, and maps it to a restricted set of values, which correspond to actual modulation levels that can be achieved on a target SLM (the different quantised phase retardation levels may need not have a regular distribution). The number of quantisation levels may be set at two, for example for an SLM producing phase retardations of 0 or π at each pixel.

In embodiments the quantiser is configured to separately quantise real and imaginary components of the holographic sub-frame data to generate a pair of holographic sub-frames, each with two (or more) phase-retardation levels, for the output buffer. FIG. 3d shows an example of such a system. It can be shown that (depending on the implementation of the procedure) for discretely pixellated fields, the real and imaginary components of the complex holographic sub-frame data are uncorrelated, which is why it is valid to treat the real and imaginary components independently and produce two uncorrelated holographic sub-frames. In other approaches only the real or only the imaginary part is used.

An example of a suitable binary phase SLM is the SXGA (1280×1024) reflective binary phase modulating ferroelectric liquid crystal SLM made by CRL Opto (Forth Dimension Displays Limited, of Scotland, UK). A ferroelectric liquid crystal SLM is advantageous because of its fast switching time. Binary phase devices are convenient but preferred embodiments of the method use so-called multiphase spatial light modulators as distinct from binary phase spatial light modulators (that is SLMs which have more than two different selectable phase delay values for a pixel as opposed to binary devices in which a pixel has only one of two phase delay values). Multiphase SLMs (devices with three or more quantized phases) include continuous phase SLMs, although when driven by digital circuitry these devices are necessarily quantised to a number of discrete phase delay values. Binary quantization results in a conjugate image whereas the use of more than binary phase suppresses the conjugate image (see WO 2005/059660).

### Adaptive OSPR

In the OSPR approach we have described above subframe holograms are generated independently and thus exhibit independent noise. In control terms, this is an open-loop system. However one might expect that better results could be obtained if, instead, the generation process for each subframe took into account the noise generated by the previous subframes in order to cancel it out, effectively “feeding back” the perceived image formed after, say, n OSPR frames to stage n+1 of the algorithm. In control terms, this is a closed-loop system.

One example of this approach comprises an adaptive OSPR algorithm which uses feedback as follows: each stage n of the algorithm calculates the noise resulting from the previously-generated holograms H₁ to Hₙ₋₁, and factors this noise into the generation of the hologram Hₙ to cancel it out. As a result, it can be shown that noise variance falls as 1/N² in comparison to the 1/N falloff for (non-adaptive) OSPR. An example procedure takes as input a target image T, and a parameter N specifying the desired number of hologram subframes to produce, and outputs a set of N holograms H₁ to H_{N} which, when displayed sequentially at an appropriate rate, form as a far-field image a visual representation of T which is perceived as high quality.

An optional pre-processing step performs gamma correction to match a CRT display by calculating T(x, y)^{1.3}. Then at each stage n (of N stages) an array F (zero at the procedure start) keeps track of a “running total” (desired image, plus noise) of the image energy formed by the previous holograms H₁ to Hₙ₋₁ so that the noise may be evaluated and taken into account in the subsequent stage: F(x, y):=F(x, y)+|F [Hₙ₋₁(x, y)]|². A random phase factor φ is added at each stage to each pixel of the target image, and the target image is adjusted to take the noise from the previous stages into account, calculating a scaling factor α to match the intensity of the noisy “running total” energy F with the target image energy (T′)². The total noise energy from the previous n−1 stages is given by αF−(n−1)(T′)², according to the relation

$$α := \frac{{\sum }_{x , y} {{T}^{′} ( x , y )}^{4}}{{\sum }_{x , y} F ( x , y ) \cdot {{T}^{′} ( x , y )}^{2}}$$

and therefore the target energy at this stage is given by the difference between the desired target energy at this iteration and the previous noise present in order to cancel that noise out, i.e. (T′)²−[αF−(n−1)(T′)²]=n(T′)²+αF. This gives a target amplitude |T″| equal to the square root of this energy value, i.e.

$${T}^{″} ( x , y ) := \{ \begin{matrix}\sqrt{2 {{T}^{′} ( x , y )}^{2} - α F} \cdot exp \{ j φ ( x , y ) \} & if 2 {{T}^{′} ( x , y )}^{2} > α F \\ 0 & otherwise\end{matrix}$$

At each stage n, H represents an intermediate fully-complex hologram formed from the target T″ and is calculated using an inverse Fourier transform operation. It is quantized to binary phase to form the output hologram Hₙ, i.e.

$$H ( x , y ) := {F}^{- 1} [ {T}^{″} ( x , y ) ]$$

$${H}_{n} ( x , y ) = \{ \begin{matrix}1 & if Re [ H ( x , y ) ] > 0 \\ - 1 & otherwise\end{matrix}$$

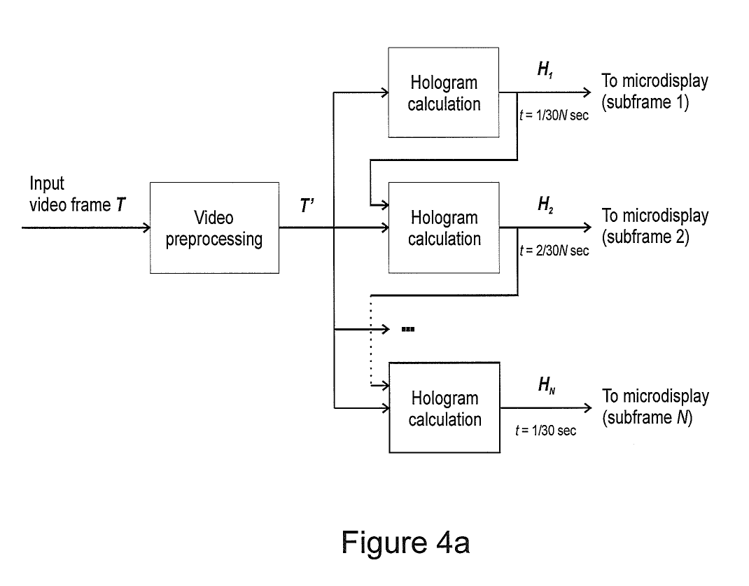

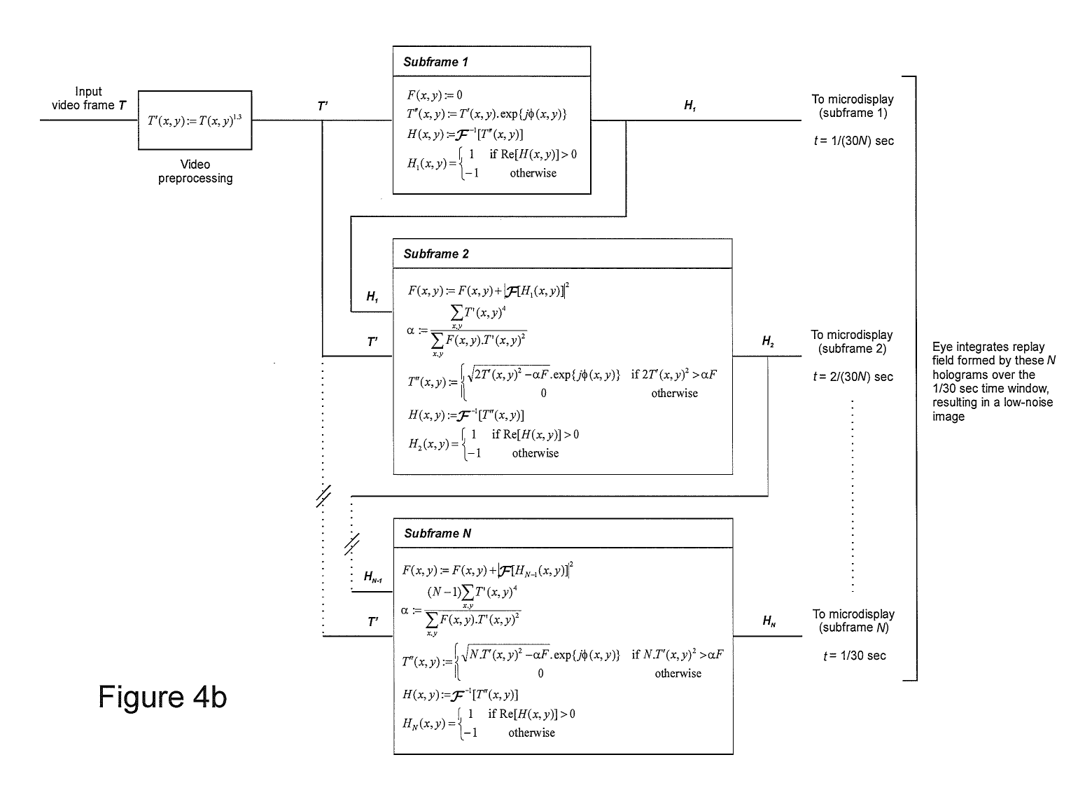

FIG. 4a outlines this method and FIG. 4b shows details of an example implementation, as described above.

Thus, broadly speaking, an ADOSPR-type method of generating data for displaying an image (defined by displayed image data, using a plurality of holographically generated temporal subframes displayed sequentially in time such that they are perceived as a single noise-reduced image), comprises generating from the displayed image data holographic data for each subframe such that replay of these gives the appearance of the image, and, when generating holographic data for a subframe, compensating for noise in the displayed image arising from one or more previous subframes of the sequence of holographically generated subframes. In embodiments the compensating comprises determining a noise compensation frame for a subframe; and determining an adjusted version of the displayed image data using the noise compensation frame, prior to generation of holographic data for a subframe. In embodiments the adjusting comprises transforming the previous subframe data from a frequency domain to a spatial domain, and subtracting the transformed data from data derived from the displayed image data.

More details, including a hardware implementation, can be found in WO2007/141567 hereby incorporated by reference.

### Colour Holographic Image Projection

The total field size of an image scales with the wavelength of light employed to illuminate the SLM, red light being diffracted more by the pixels of the SLM than blue light and thus giving rise to a larger total field size. Naively a colour holographic projection system could be constructed by superimposed simply three optical channels, red, blue and green but this is difficult because the different colour images must be aligned. A better approach is to create a combined beam comprising red, green and blue light, as shown in FIG. 2 above, and to provide this to a common SLM, scaling the sizes of the images to match one another.

An example system comprises red, green, and blue collimated laser diode light sources, for example at wavelengths of 638 nm, 532 nm and 445 nm, driven in a time-multiplexed manner. Each light source comprises a laser diode and, if necessary, a collimating lens and/or beam expander. The total field size of the displayed image depends upon the pixel size of the SLM but not on the number of pixels in the hologram displayed on the SLM. A target image for display can be padded with zeros in order to generate three colour planes of different spatial extents for blue, green and red image planes. In the holograms for each colour plane the information in the hologram is distributed over the complete set of pixels.

### Aberration Correction

As we have explained above the aberrations in the holographic image display system may be considered as a phase error at each point of the SLM, affecting each image point in the same way. To correct for them we note that the rendering process produces a hologram, which we display some approximation to on the SLM (it is an approximation since the SLM is not capable of modulating each of its pixels with arbitrary phase and amplitude). Thus, after computing the hologram but before computing this approximation we adjust the phases according to the aberration field. In principle, if there is no field-dependent aberration and we know the aberration field exactly, this produces results exactly as good as if there were no aberration at all.

The problem, then, is to measure the aberration field. We would like to measure what the phase errors are at each pixel of the SLM, and we would like to do so without having to disturb the projector (e.g. by removing or replacing some of its optical elements), and we would like the process to be simple, quick and robust.

### Holographic Wavefront Sensor

Imagine that we augment the capabilities of the SLM: as well as modulating the phase of the light incident on it, it can now block it out completely. Now, block out all light apart from that incident on a small patch of the SLM; and set all the pixels in that patch the same way, so that the phase change imposed by the SLM is constant across the patch.

What we then have is effectively one subunit of a wavefront sensor, with the projector's projection lens projecting light at an angle which depends on the gradient of the phase over the patch. We may measure (for example, by using a CCD-type imaging sensor) the position of the resulting spot, which will be on the zero-order axis of the projector if the average phase gradient over the patch is zero, and otherwise will deviate from that position proportionately to that phase gradient, and thereby measure the average phase gradient over the patch.

It is not desirable to place the nominal position of the spot on the zero-order axis, because the modulation of the SLM is not perfect and a non-negligible amount of stray light ends up there. Furthermore it is preferable to design a projector, if it has a binary phase SLM, so that it produces an image and a conjugate image on either side of the zero order spot so that the axis of the projection lens corresponds not to the zero order of the SLM but to the middle of the projected image. Thus a spot projected out along the zero-order axis might have its position badly distorted, complicating the measurement process. Therefore instead of imposing a constant phase on the SLM in the patch being measured, it is preferable to put a phase ramp on the SLM that moves the nominal spot position to the centre of the image. In general the phase ramp will be quantised in accordance with the capabilities of the SLM, and this will introduce error. The error typically comprises random-looking noise, and this may be reduced by displaying temporal sub frames, in a similar way to that described above for rendering ordinary images. It is preferable to choose a different phase offset for the ramp in each subframe, preferably spacing them all approximately equally round the unit circle. Over a patch a linear phase ramp bends light in the “ramp direction”, with a bigger deviation for a faster phase change (the sine of the angle of inclination in the x-direction is proportional to ∂N/∂x, and in the y-direction to ∂N/∂y). The average direction (centroid of a spot) is given by the average d(phase)/d(position).

In general there will not be a facility in the projector to black out parts of the SLM (instead the SLM transmits light with adjustable phase) Therefore, we use the rest of the SLM—the part not being measured—to display an image in which all the light is directed somewhere well separated from the centre of the image. That could be the edges of the image, or the zero order, or wherever else is convenient. One can do this either by rendering (in the usual way) an image which is dark in the middle, and then replacing one patch of the resulting hologram with a phase ramp, or by placing a “synthetic” pattern on the rest of the SLM: for example, all pixels the same to send the light in to the zero order, a checkerboard pattern to send to the corners of the image and so forth.

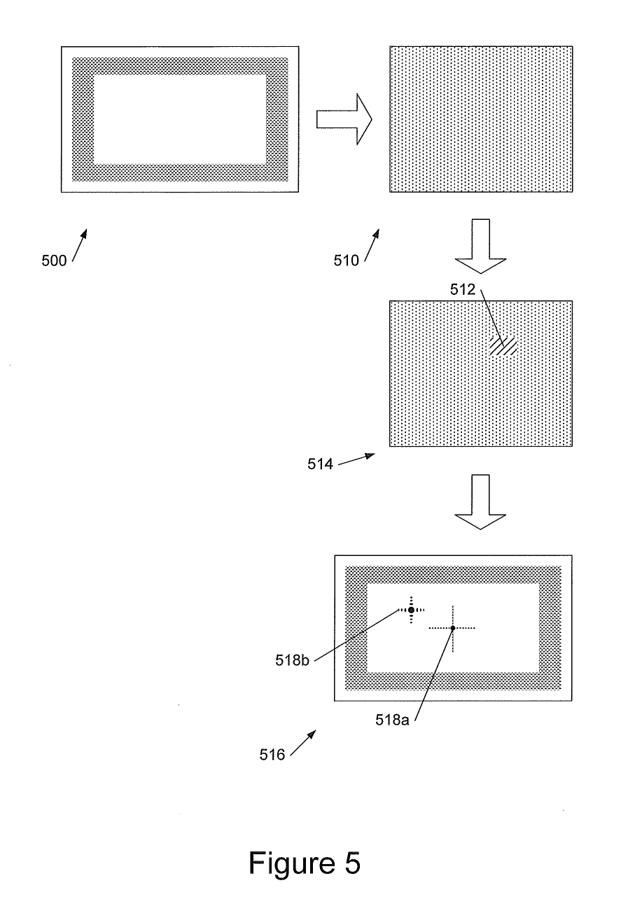

This procedure is illustrated, schematically, in FIG. 5. This shows an initial image of 500, in this example comprising a fuzzy band of light around the edge of the image plane, which is converted to a corresponding (complex) hologram 510 by a phase randomization and (fast) Fourier transform procedure as previously described. Then a patch 512 of the hologram 510 is replaced by a phase ramp to produce a wavefront sensing hologram 514. This is then projected to produce a displayed image 516 comprising the fuzzy band of light around the edge of the image and having a notional spot position 518a determined by the phase ramp 512. The actually displayed image, however, has a fuzzy spot at a different location 518b, the difference between the notional and actual positions providing information on aberrations in the selected patch. If the wavefront sensing hologram is projected during a second or subsequent iteration of the aberration correction procedure (see below) a previously determined aberration correction is applied to hologram 514 to project an aberration-corrected hologram to enable residual aberrations in the selected patch to be determined.

Note that the sensor is now effectively placed right where the SLM is: what we measure is the way in which phase varies over a particular patch of the SLM. Further, there is no need to interfere with the projector's optics, which we just leave in their usual operating state: the projector is pointed at a flat screen, as (typically) in its usual mode of operation. The spot-measurement is typically carried out by a digital imager viewing the projected image. (It is usually preferable to use a rear-projection configuration so that the camera can be looking along the axis of projection rather than at an angle, but front-projection is also possible).

This measurement is performed for many patches; they may, but need not, form a square or rectangular tiling of the SLM. (Even if they do form such a tiling, one may combine multiple measurements using different tilings).

Having measured all their average gradients, we estimate the overall phase field using any additional information known about the nature of the aberrations (this will be out by an unknown constant, but this does not matter). For instance, one may assume that they are well modelled by a low-order polynomial in x and y (the position on the SLM) and estimate that polynomial's coefficients by linear least squares using our average derivative information. Alternatively one may use a more sophisticated model of how the aberrations arise and compute a maximum a posteriori estimate of them. Or one may assume that the aberrations are reasonably smooth, and compute a spline approximation on the basis of the estimated derivatives.

### Beam Profile

The light incident on the SLM is not uniform in brightness. This means that the measured spot position from a single SLM patch is not simply the average phase gradient over the patch. Instead, it turns out that the spot position is proportional to a weighted average of the phase gradient, where the weight is the intensity of the incident light.

Conveniently the procedure used for measuring the phase variation also enables measurement of the illumination intensity profile: we simply measure how much light there is in each spot. Since the illumination varies smoothly and quite slowly across the SLM, we can then fit a simple model to the measured intensities and use that to estimate how the illumination is varying across each patch. This information can then be used in estimating the aberrations. In mathematical terms we determine an approximate solution φ of:

$$\frac{{\int }_{{patch}_{i}} \frac{\partial φ}{\partial x} \cdot {I}_{i} ( x , y ) d x d y}{{\int }_{{patch}_{i}} {I}_{i} ( x , y ) d x d y} = [ measured spot displacement for {patch}_{i} ] \qquad ( 1 )$$

(together with a corresponding set of equations for y) where I may be modelled, for example, as a radially symmetric Gaussian with given centre and falloff rate (numerous other possibilities will readily occur to the skilled person) and some of the possibilities for parameterizing φ have already been discussed.

It will typically not be possible for all these equations to be solved exactly, nor is it desirable that they should be; there will inevitably be measurement errors, and having more measurements than adjustable parameters helps to reduce their impact. Typical model-fitting procedures such as linear least squares are able to place more importance on some equations than others. It is desirable to do this in the procedure described here, so that measurements are trusted more and given more influence over the estimate of φ when they are likely to be more accurate, and when they describe regions of the SLM on which a lot of light falls. The former may be roughly estimated by the measured intensity of each patch's spot (dimmer spots are more severely affected by sensor noise and quantization error) and the latter by the modelled total intensity on each patch.

If the illumination profile when the projection system is in use after aberration correction differs from the one used in measurement of aberrations, the only part of this that would change is the estimate of how much light each patch contributes to the image. In practice, the illumination profile should not change appreciably, and it would need to change a lot to make much difference to the image.

### Distortion Correction

With perfect projection and camera optics, the deviation of the measured position of each spot from its nominal position would simply be proportional to the (weighted) average phase gradient on the patch being measured. However in the real world, we preferably begin by measuring where a given amount of phase gradient puts a spot for various different gradients, and then interpolate.

However until we have measured our aberrations quite well, we (1) cannot be sure what average phase gradient we have in any spot we project and (2) cannot measure the position of any spot accurately, since the spots are badly aberrated. One can solve this problem by iterating: first we make a very crude measurement of the position/phase-gradient correspondence (with badly aberrated spots, whose positions we can measure only roughly), then we use that to take an aberration measurement, then we use the (not very accurate) results of that to correct our aberrations (imperfectly, but typically quite well enough) and start again; we now have a flatter phase field and much smaller spots, so we can measure the position/phase-gradient correspondence much more accurately. It can be helpful to use a smaller number of larger patches for the initial measurement, to save time.

The following procedure has been found effective when measuring the correspondence between phase gradient and spot position, although the skilled person will appreciate that other approaches are also possible:
Consider a 3×3 grid of spot positions, centred in the middle of the image and separated by a fixed distance approximately 10% of the image height. (A fixed distance in “notional” image space, corresponding to a fixed change in phase gradient.)
For each of these spot positions, display a spot at that position, capture an image of it, and measure where it appears in the image (see below for details of measuring spot position). We now have nine quadruples (phase_dx, phase_dy, pos_x, pos_y).
Perform a least-squares fit to find bivariate quadratic polynomials px, py such that for the nine measurements the relations phase_dx=px(pos_x, pos_y) and phase_dy=py(pos_x, pos_y) approximately hold. By “bivariate quadratic”, is meant a function of the form px=A+Bx+Cy+Dx²+Exy+Fy²; this gives enough freedom to represent typical actual distortions well enough, but enough redundancy to protect a little against measurement error.

### Field-Dependent Aberration

As previously mentioned, it is preferable to minimize field-dependent aberration in the projectors by design. However, suppose we have a projector whose field-dependent aberrations are not negligible, and wish to calibrate it as best we can. One approach is to project multiple spots for each patch we are measuring (by imposing different phase ramps on the patch) and thereby estimate what the phase gradient looks like for any given position in the image plane; then (for instance) if we wish to measure the aberrations in the centre of the image plane, interpolate to estimate the phase gradient over the patch at the centre of the image plane.

The multiple spots may be projected successively or simultaneously; to do the latter, one can use the rendering procedures described above or a simplified version of them, to make the SLM patch into a hologram whose image has multiple points in image space. More or less equivalently, one could superpose phase ramps corresponding to the points where we want to place our spots.

Doing this is liable to introduce more quantization error, and therefore produce inferior spots. For projectors without significant field-dependent aberration, we have found that this makes for less accurate aberration measurement.

More explanation relating to field dependent aberration is given later.

### Measuring Spot Positions

In a practical environment, accurate measurement of the spot positions may be difficult. The spots produced by this procedure are typically quite large because one is using only a small part of the SLM. If, say, a patch 1/10 of the linear size of the SLM is employed, then the linear size of the spot will be at least 10 times the size of a perfect spot using the full SLM, which is to say (in a well designed projector) at least 10 times the diffraction limit. Furthermore, the spots are liable to be quite dim, especially towards the edge of the SLM where the incident illumination is relatively low, and they will be affected by speckle. And, unless it happens that the aberration field over the SLM patch being measured is a pure linear phase ramp, the spot will be aberrated as well as displaced.

If one abstracts away all the non-idealities, one finds that it is the centroid of the spot intensity whose position corresponds to the weighted average phase gradient. In practice, as the skilled person will appreciate, it is usually preferable to measure spot position in ways that are more robust against quantization error, noise, and saturation. For instance, digital filtering may be employed to reduce noise, or the shapes of typical spots may be modelled and a maximum-likelihood or maximum a posteriori procedure used to estimate the spot position.

We have found the following procedure effective, although many others are also possible:
Capture an image of the spot.
Convolve it with a simple filter that averages intensities over a roughly circular region. (For any sensible choice of filter, the spot centroid is not affected by this, or is simply shifted by a constant and readily calculated amount).
Estimate the level of background noise (which will have been greatly attenuated by the filtering) by looking at dim parts of the image. Subtract off an estimate of the average noise; set to zero any pixels whose intensities are not significantly in excess of that level.
Estimate the position of the centre of the spot using some crude but robust method; for instance, the point of maximum intensity.
Adjust the measured pixel intensities to make them fall off substantially away from this estimated centre point. (Leave pixels near to the centre point unaltered).
Re-estimate the spot centre, and adjust the pixel intensities again. Repeat a few times. The effect of this procedure is to replace most of the background noise remaining in the image with zeros, with the remaining background noise approximately symmetrically placed relative to the centre of the spot; this makes the following centroid calculation less noisy.
Measure the centroid of the resulting spot image.

### Iterated Measurement

We have already described one reason for preferably taking repeated measurements: the desire for reasonable quality spot-position measurements, which may not be available until we there is at least a crude estimate of the aberrations. There are other reasons, which can make it preferable to iterate for longer.

When the wavefront phase is varying rapidly across a single SLM patch, the resulting spot will be some distance from the centre of the image. This may be undesirable for several reasons. (1) If there is field-dependent aberration, the aberrations measured for different spots will then be taken from different parts of the image, resulting in aberration correction that theoretically is not correct anywhere. (2) If there is distortion in the projection lens, the position measurements will be more accurate nearer the centre. (3) If there is distortion in the projection lens, not only the position but the shape of the spot may be distorted; the centroid of the distorted spot need not be the same as the distorted position of the centroid of the undistorted spot. (4) If there is vignetting in the projection lens, the projected spot may be affected by a falloff in intensity that varies across its extent, leading again to mis-measurement of the centroid. (5) The camera will need to cover a larger region, incurring reduced resolution and increased noise.

However if we have at least a rough estimate of the aberrations, we may correct for them: instead of just placing a phase ramp on the SLM patch, multiply it pointwise by the inverse of the estimated aberrations. Then one is measuring not the aberrations themselves but their deviation from the estimate, which will hopefully be much smaller.

The following procedure has been found effective:
Make a very crude estimate of the position/phase-gradient correspondence by projecting (uncorrected) spots with known phase ramps applied to them, and attempting to measure the centroids of the resulting spots.
Perform a very quick aberration measurement, using only say 4×4 or 5×5 patches.
Using the results to deaberrate the spots, re-measure the position/phase-gradient correspondence.
Perform a more careful aberration measurement, typically using say 10×10 patches. Correct the aberrations using either the aberrations just measured or (if computing the required holograms is expensive) one of a small number of pre-computed sets of holograms for an aberration that somewhat resembles the one that has been measured.
Optionally, measure again, correcting using the aberrations just measured.

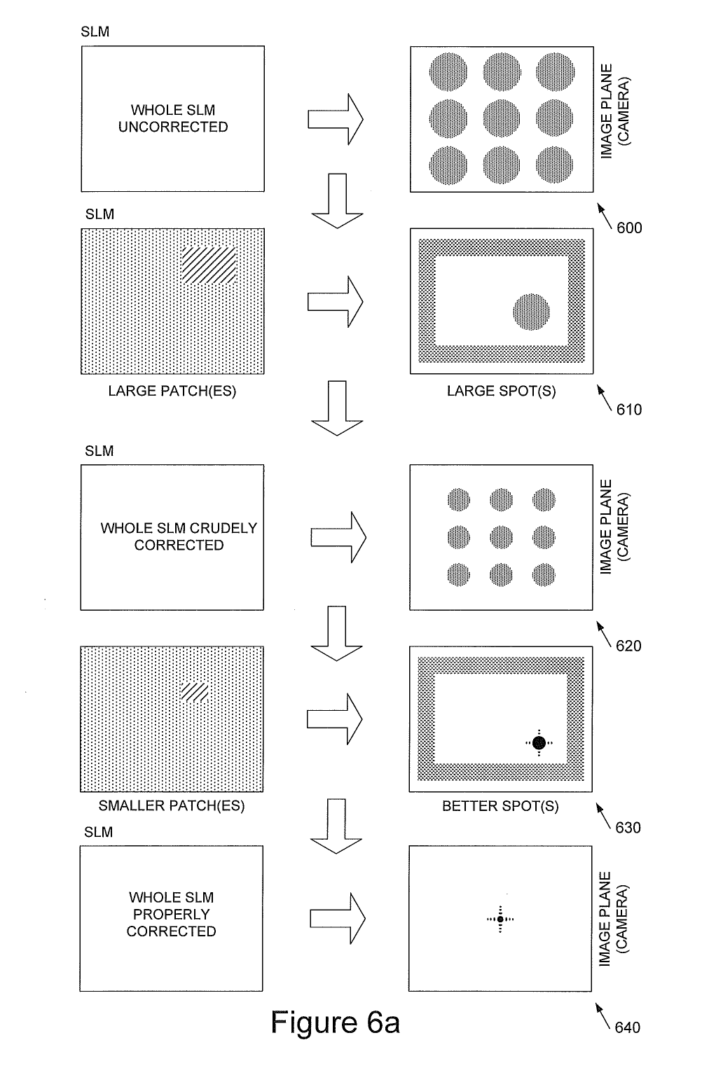

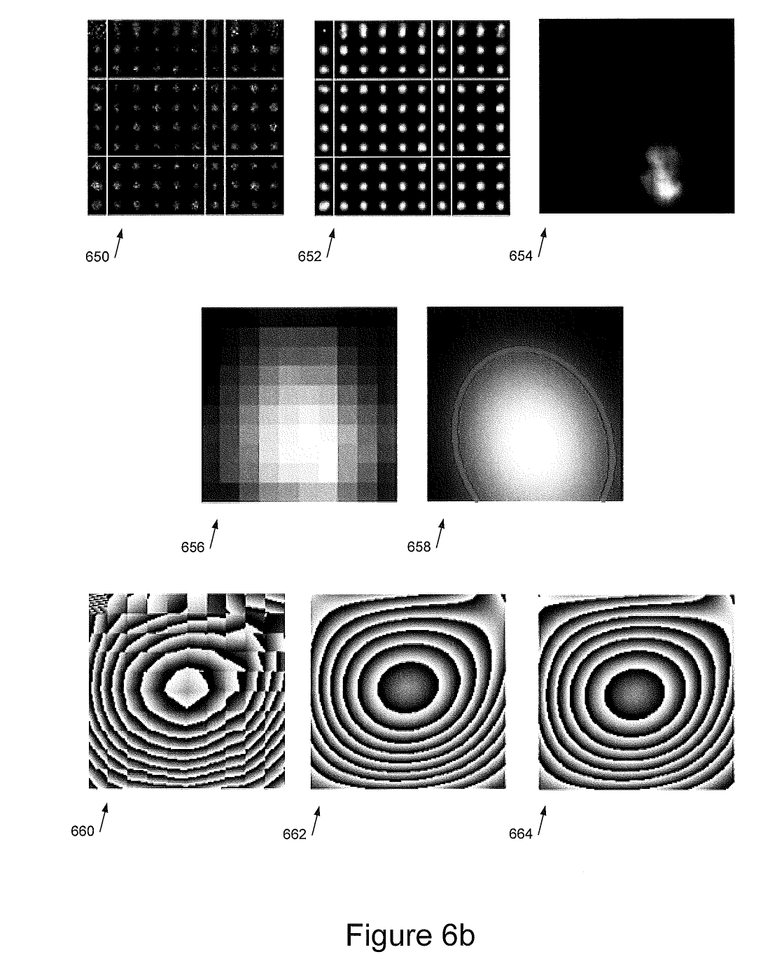

Referring to FIG. 6a, this shows diagrammatically a procedure for correcting aberrations according to an embodiment of the invention. Thus in a first stage 600 of the procedure a phase gradient is displayed across the whole of the uncorrected SLM for each of a set of target spot positions, for example a grid of spot positions as shown. At this stage the spots are typically large and diffuse due to aberration. An image of each spot is captured by the camera and used to perform an initial calibration of phase gradient to spot position, as previously described.

Then in a second stage 610 relatively large patches on the SLM are used for an initial, relatively crude determination of optical aberrations in the holographic image display system. This is performed by determining a smooth aberration correction from the averaged aberrations over the patches (weighted by the beam illumination profile), according to the procedure already described. This concludes what could be termed “iteration 0”. Its results will be inaccurate because all the spots measured in iteration 0 are badly aberrated, and because the SLM has been sampled only very coarsely. Then, at stage 620, the SLM is crudely corrected using the data from iteration 0 and this is used to determine a better camera calibration from smaller spots in the image plane. Then, at stage 630, smaller patches are employed on the crudely corrected SLM and the positions of the corresponding (better) spots are measured and the aberrations are once again mapped, this time more accurately (iteration 1). Further iterations may be performed if desired. Finally, at stage 640, the SLM can be properly corrected and a check is performed by imposing a constant phase or phase gradient (together with the just-measured aberration correction) over the whole SLM, to confirm that a high quality spot is produced in the image plane; the size of this spot can be measured to check the performance of the correction.

Referring now to FIG. 6b, this shows example images corresponding to those of the procedure diagrammatically illustrated in FIG. 6a. Thus image 650 shows, superimposed, raw captured image data for a set of spots from iteration 1 (stage 630) of the preceding procedure. It can be seen that the quality of some of these spots is very poor, for example that in the top left hand corner. In general this occurs for patches of the SLM which have very little illumination. The raw spots illustrated in image 650 are arranged on a grid for convenience—the positions of the spots do not correspond to their actual displayed positions but instead the spot images are located according to the patches used to produce the spots; arranging these spots in an array merely provides a convenient way of reviewing the quality of the raw captured spots. Prior to measuring spot positions (centroids) the raw image data is pre-processed to reduce speckle and camera noise, as previously described, and an example of the cleaned up spots is shown in image 652. Image 654 shows an example of a (cleaned up) spot, in this image showing the spot position, the illustrated spot being generated by patch or block (10/10, 10/10), that is the 10^{th} patch of 10 in each of the x- and y-directions. (In image 652 this spot appears at the top right hand corner). The spot is relatively large in part because of the relatively small fraction (patch) of the SLM used to generate the image of the spot.

Image 656 shows a map of illumination of the SLM, derived from intensity measurements of the spots generated by the patches on the SLM. Alongside this is shown a two-dimensional Gaussian fit 658 to the illumination distribution.

Image 660 shows (the linear) gradient of phase aberration for each patch on the SLM as derived from the measured spot positions. Although the tilt is shown for each of the spots/patches in image 660 the offsets (which are in effect a free parameter) are chosen so that the patches approximately match up at their edges, which makes it easier to appreciate the estimate of the aberrated wavefront. It can be seen that the patch in the top left hand corner apparently merely comprises noise; this corresponds to the very noisy “spot” in the top left hand corner of image 650, and can be understood from image 656 which shows that there is little or no illumination of the SLM in this corner. However the previously described weighting process will ensure that little or no weight is placed on the data from this patch when fitting the model of phase aberration correction. Image 662 shows a fit of the data in image 660 to an expansion in terms of Zernike polynomials. Image 664 shows the same Zernike fit to the aberrated wavefront, but in image 664 the tilt coefficients are forced to zero (these are coefficients of the form Ax, By). The effect of these coefficients is merely to translate the position of a spot in the x- and/or y-direction and thus they are not required for wavefront correction—a translation of the entire image in the x- and/or y-direction can be corrected in other ways, for example while preprocessing the image to take account of distortions in the projection lens, and therefore these coefficients can be discarded.

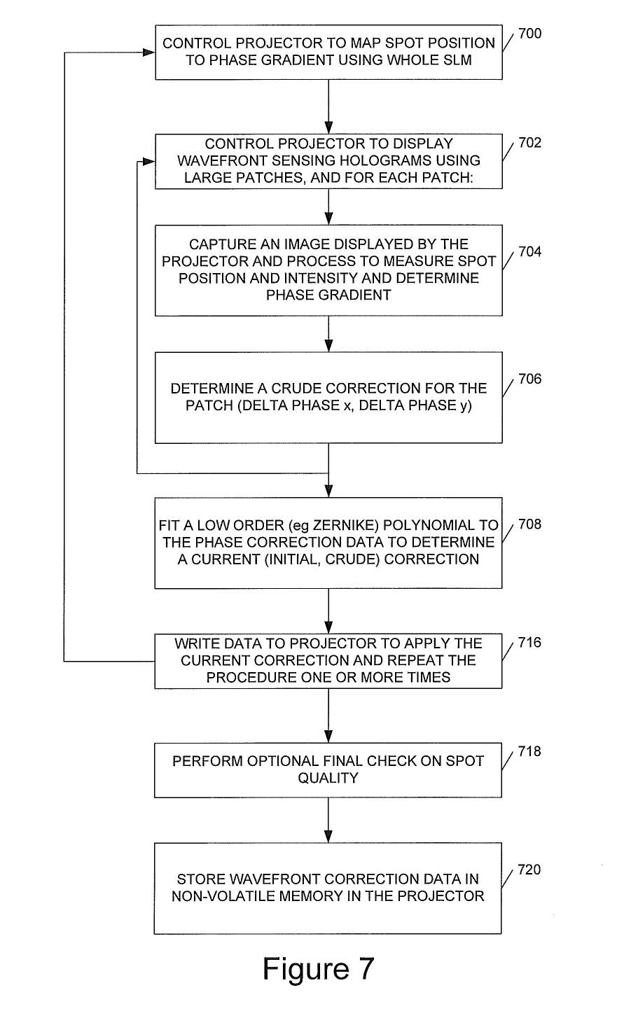

Referring now to FIG. 7, this shows a flow diagram of a procedure for performing an aberration correction according to an embodiment of the invention. Broadly speaking the procedure corresponds to that shown diagrammatically in FIG. 6a. Thus the procedure begins its step 700 by controlling the holographic image display system to map spot position to phase gradient, one at a time, for spots in a grid of spots, preferably using the whole SLM at this point (uncorrected). Then (step 702) the display system is controlled to display a set of wavefront sensing holograms comprising a first set of relatively large patches tiling the SLM. For each patch an image of the displayed spot is captured and processed to determine spot position, and hence phase gradient, and also spot intensity. Then (step 706) a crude phase gradient correction for the patch (x-direction gradient and y-direction gradient) is determined, and the procedure loops until a crude correction for each patch has been produced. Then (step 708) a low order polynomial, for example a combination of the first few Zernike modes, is fitted to the patch phase correction data to determine an initial, relatively crude set of aberration data. This is written to the holographic projector (step 716) so that this crude correction data can be applied when displaying further wavefront sensing holograms. The procedure then loops back to step 700 for one or more further iterations as previously described. The result is an accurate set of aberration (wavefront) correction data, which is written to the projector for storage in non-volatile memory at step 720. Optionally the procedure may perform a final check on spot quality (step 718) prior to uploading the wavefront correction data.

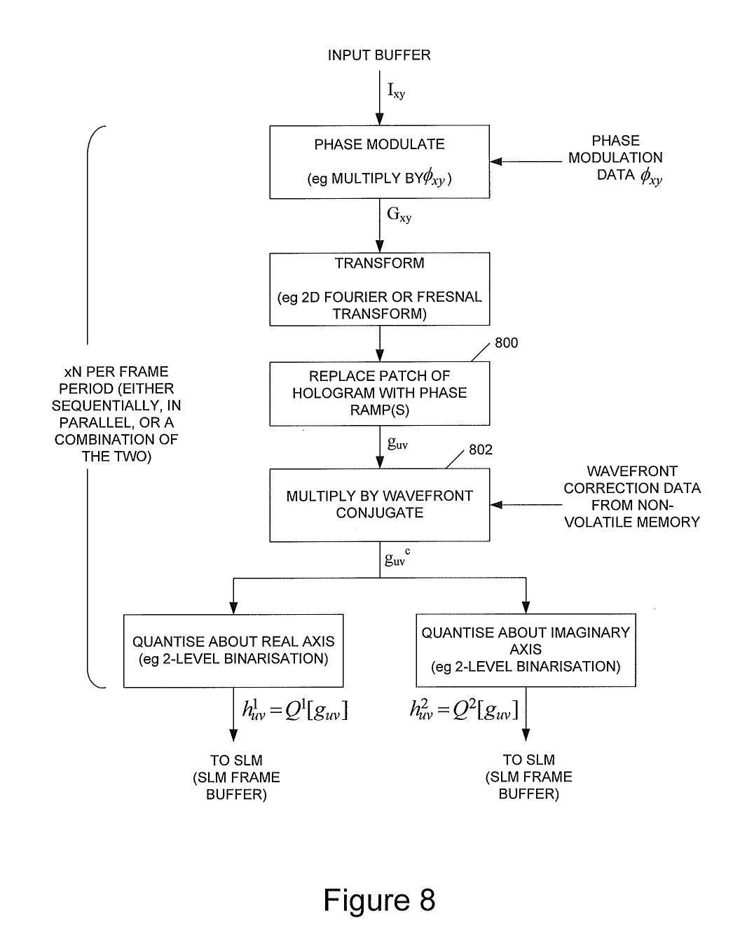

FIG. 8 shows a procedure similar to that illustrated in FIG. 3d for use by a holographic image display system as previously described when displaying a wavefront sensing hologram. The input image data comprises an image in which the light is directed away from the centre of the image, for example towards a fuzzy border around the edge of the image plane. At step 800 a patch of the hologram is replaced with one or more phase ramps (depending upon whether or not multiple spots are to be display simultaneously) and then the wavefront sensing hologram is corrected according to the iteration in the procedure—no corrections available for iteration 0, but subsequently wavefront correction data is available to apply to a wavefront sensing hologram. Thus at step 802 wavefront correction data is loaded from non-volatile memory in the projector (or retrieved from a controlling computer system) and the hologram data is multiplied by the conjugate of the wavefront defined by the wavefront correction data to generate corrected hologram data. This corrected hologram data is then quantised according to the capabilities of the SLM (it is preferable to apply the correction prior to quantisation).

The wavefront correction may be represented in terms of Zernike modes. Thus a wavefront W=exp(iΨ) may be expressed as an expansion in terms of Zernike polynomials as follows:

$$W = exp ( i Ψ ) = exp ( i {\sum }_{j} {a}_{j} {Z}_{j} ) \qquad ( 2 )$$

Where Zⱼ is a Zernike polynomial and aⱼ is a coefficient of Zⱼ. In the present context, W is the complex conjugate of the aberration field. Thus, for (uncorrected) hologram data gᵤᵥ, the corrected hologram data gᵤᵥ^{c} can be expressed as follows:

gᵤᵥ^{c}=exp(iΨ)gᵤᵥ (3)

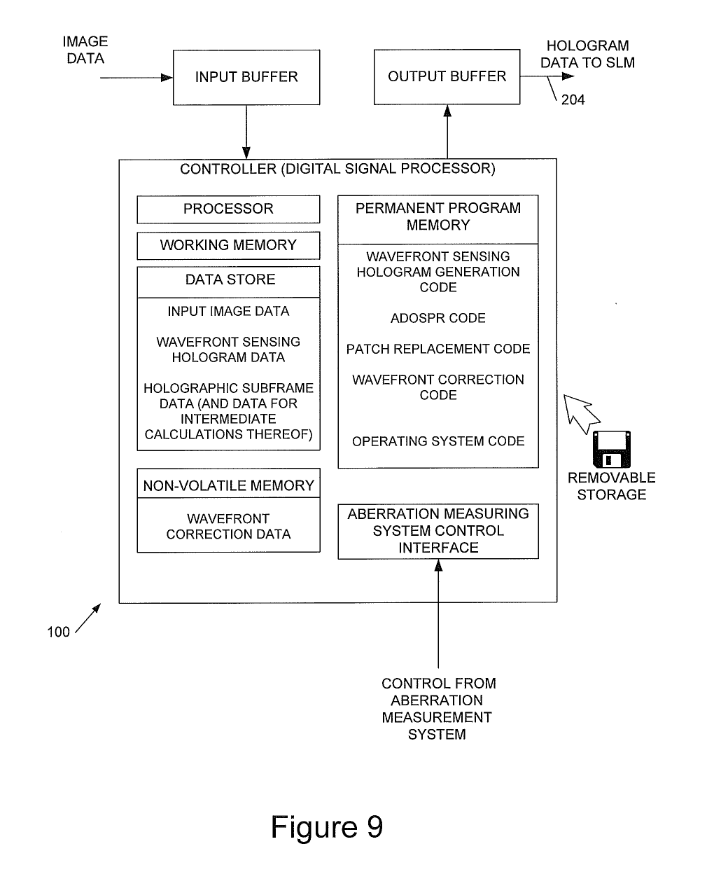

Referring now to FIG. 9, this shows a block diagram of one implementation of processor 100 of the holographic image display systems of FIGS. 1 and 2, configured to work with a method as described above. The processor may be implemented in hardware, or software, or a combination of the two; the illustrated embodiment employs primarily software and includes code and/or data for generating the wavefront sensing hologram, including replacement of a selected patch of defined size with a phase gradient, non-volatile memory storing wavefront correction data, and hologram wavefront correction code to apply the wavefront correction. The processor also includes an interface to receive control signals from the computer system controlling the aberration measurement and determining the aberration corrections.

### Measuring Multiple Patches at Once

This is an optional potential refinement of the technique: If the projector is known to have very little field-dependent aberration, one can speed up the measurement process by operating on multiple SLM patches simultaneously: impose a different phase gradient on each, so as to put the spots' nominal positions in known and widely separated places. The larger the aberrations one must deal with, the less scope there is for doing this. If the expected aberrations are small enough, one might for instance divide the SLM into (say) P patches alone each axis and use each to form a spot at one of P² nominal locations in the image. For typical values of P, the amount of space this leaves for each spot is small compared to the size of the image, and the approach is viable only if the aberrations are known in advance to be so small that the spots remain within the space allotted to them.

However, perhaps more preferably, one could choose to measure a small number of patches together; perhaps four at a time. If four adjacent patches are chosen then typically the average phase gradients on the patches will be similar to one another, so that the deviations of the spot from their nominal position are all similar, reducing the risk that the spots might collide or exchange places.

### Modelling the Wavefront Phase and Amplitude

For well designed and manufactured projectors, it has been found appropriate to model the phases measured as depending on SLM position according to a low-order polynomial. We estimate the coefficients of the polynomial using least-squares fitting (typically in the Zernike basis, but other choices are possible). We give higher weights to patches where more light is present, so as to be less vulnerable to measurement error.

In preferred embodiments we model the amplitudes as bivariate Gaussians (with arbitrary variances and covariances, so that the model can represent “elongated” and non-axis-aligned intensity profiles). We estimate the parameters of the Gaussian by least-squares fitting, but this is a nonlinear least-squares problem rather than a linear one and therefore requires a more expensive computation.

### Hardware Support

In ordinary use, the projector is fed with images through (for instance) an HDMI connection; it captures these at regular intervals and renders them. In order to avoid needing a special mode of operation in which holograms are uploaded directly to the projector, it is preferable to give the projector the ability to synthesize the holograms it needs. The “background image”, sending light out towards the edges of the image field, may be rendered in the OSPR-type manner previously described and the projector is provided with the ability to replace one patch of the hologram with a simple phase ramp. In order to be able to apply approximate aberration correction during the calibration process for the iterated method described above it is desirable for this replacement to happen before aberration correction. It is possible and also advantageous to generate the background image not by frame capture but synthetically.

### Field Dependent Aberration—Further Detail

In more detail, aberration is the result of “wrong” optical path lengths from laser to image via SLM. One may consider only shortest (straight-line) paths between these entities. Treating the laser as a point source (or at least a spatially coherent one), the “wrongness” depends only on where the path meets the SLM and where it meets the image. Its dependence on the image point is what we call field-dependence. Usually, the SLM point makes a much bigger difference.

The aberration-measuring procedure we have described involves sending light through particular regions of the SLM to (notionally) a particular point in the image plane. However, the spot does not always land at the same point in the image plane (indeed, it is the deviations from always landing at the same point that we are measuring). Therefore, when the aberrations are field-dependent what is measured is some mixture of aberrations corresponding to different image points.

One can address this by making all the spots land at almost exactly the same place—doing multiple iterations achieves this because each iteration after the first is effectively working with a system to which the previous iteration's corrections have been applied, leaving only relatively small residual aberrations and therefore making each spot's actual position close to its nominal position—and/or by working out not what spot position deviation we get with a particular phase ramp on the SLM patch but what phase ramp we require to get the spot exactly onto its target position. One can implement this latter approach by displaying multiple spots and interpolating between them.

One could implement #1 by arranging that for each SLM patch we generate multiple spots as described above. If it is desired to choose their location in advance, we may not be able to arrange for any of them to land right on the target location; but we may be able to interpolate between them: “A phase ramp with gradients (dx1,dy1) produces a spot at location (x1,y1); one with gradients (dx2,dy2) produces a spot at (x2,y2); and so forth; so the relationship between phase gradient and spot location can be determined; so gradients (dx,dy) would produce a spot at (target_x,target_y).” Then (−dx,−dy) are the measured average phase (error) gradients for a spot at (target_x,target_y).

One can generate these multiple spots either successively or simultaneously. To generate them simultaneously, the hologram on the relevant part of the SLM is a linear superposition of phase ramps, which is not the same as a linear superposition of phases.

If aberrations have been measured for a wide range of image points, then one can in principle generate holograms that correct for field-dependent aberration, although this is computationally very expensive unless the image being rendered is extremely sparse.

No doubt many other effective alternatives will occur to the skilled person. It will be understood that the invention is not limited to the described embodiments and encompasses modifications apparent to those skilled in the art lying within the spirit and scope of the claims appended hereto.

In conclusion, the invention provides novel systems, devices, methods and arrangements for display. While detailed descriptions of one or more embodiments of the invention have been given above, no doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A method of determining an aberration correction for a holographic image display system, the system comprising:
a spatial light modulator (SLM) to display a hologram;
at least one coherent light source configured to illuminate said SLM; and
projection optics to project an image formed by said illuminated, displayed hologram onto an image plane;
the method comprising:
displaying a wavefront sensing hologram on said SLM, said wavefront sensing hologram comprising a hologram having first and second spatial portions on said SLM, said first spatial portion comprising a patch of said hologram configured to direct light towards a target spot position in said image plane, said second spatial portion comprising a remainder of said hologram apart from said first spatial portion, said second spatial portion of said hologram being configured to direct light away from said target spot position in said image plane;
measuring a position of a spot in said image plane formed by illuminating said wavefront sensing hologram with said coherent light source;
determining a gradient of a phase aberration correction for said holographic image display system, to be applied at a position of said patch on said SLM, from a difference between said measured position of said spot and said target spot position;
repeating said displaying, measuring and determining for a plurality of different said wavefront sensing holograms having a plurality of different spatial positions of said patch; and
using said determined gradients of phase aberration correction to map phase aberration corrections for said holographic image display system.

2. A method as claimed in claim 1 wherein said patch of said hologram configured to direct light towards said target spot position is configured to define a phase ramp.

3. A method as claimed in claim 1 wherein said second portion of said hologram is configured to direct light towards a boundary of said image plane.

4. A method as claimed in claim 1 further comprising determining a phase mapping between an average phase gradient applied by a hologram displayed on said SLM and a displacement of a spot position in said image plane, and using said phase mapping to determine a said phase aberration correction gradient from said difference between said measured position of said spot and said target spot position.

5. A method as claimed in claim 4 wherein said set of spots determining of said phase mapping comprises:
displaying a set of holograms on said SLM each having an average phase gradient configured to project one or more spots of a set of spots, said set of spots extending over a two-dimensional region in said image plane;
measuring positions of said projected spots in said image plane; and
and determining a said phase mapping between average phase gradient and spot displacement using said measured position of said projected spots of said set of spots.

6. A method as claimed in claim 1 further comprising measuring an intensity of a said spot projected by a said wavefront sensing hologram and compensating for spatial variations in intensity of said illumination of said SLM across said SLM when using said determined gradients of phase aberration correction to map said phase aberration corrections.

7. A method as claimed in claim 1 further comprising measuring spatial variation in intensity of said illumination of said SLM over said SLM; and wherein said mapping of said phase aberration corrections comprises fitting said determined gradients of phase aberration correction to a model of variation of phase aberration correction over said SLM, weighted dependent on said spatial variations in intensity of said illumination.

8. A method as claimed in claim 1 comprising determining a first said map of phase aberration corrections using a first set of said wavefront sensing holograms having patches of a first spatial dimension; and determining a second said map of phase aberration corrections using a second set of said wavefront sensing holograms, and wherein displaying of said wavefront sensing holograms of said second set on said SLM further comprises compensating for phase aberrations in said holographic image display system using said first map of phase aberration corrections.

9. A method as claimed in claim 8 further comprising:
determining a phase mapping between an average phase gradient applied by a hologram displayed on said SLM and a displacement of a spot position in said image plane, and using said phase mapping to determine a said phase aberration correction gradient from said difference between said measured position of said spot and said target spot position; and
determining a second said phase mapping between an average phase gradient applied by a hologram displayed on said SLM and a displacement of a spot position in said image plane whilst compensating for phase aberrations in said holographic image display system using said first map of phase aberration corrections, and using said second phase mapping to map said phase aberration corrections for said holographic image display system determined using said second set of wavefront sensing holograms.

10. A method as claimed in claim 1 wherein said measuring of said position of a said spot in said image plane formed by illuminating said wavefront sensing hologram with said coherent light source comprises determining a centroid of said spot.

11. A method as claimed in claim 1 wherein said mapping of phase aberration corrections takes account of field dependent aberration in said holographic image display system by determining a set of said gradients of phase aberration correction for each spatial position of a said patch, each corresponding to a different said target spot position of a set of target spot positions, and combining corresponding measured spot positions for said set of target spot positions to determine an average gradient of a said phase aberration correction for use in mapping said phase aberration corrections.

12. A method as claimed in claim 1 wherein said first spatial portion of a said wavefront sensing hologram comprises a plurality of said patches configured to direct light towards a corresponding plurality of different said target spot positions, and wherein the method further comprises determining a plurality of said gradients of phase aberration corrections for each said displayed wavefront sensing hologram.

13. A method as claimed in claim 1 further comprising displaying a plurality of versions of each said wavefront sensing hologram each said version having a said patch with a different pattern of pixel phase delay values on said SLM, each said version being configured to direct light towards substantially the same said target spot position, the method further comprising measuring a said position of a said spot in said image plane by averaging over images or positions of said spot for said versions of said wavefront sensing hologram.

14. A method of displaying an image holographically using a holographic image display system, the method comprising:
mapping phase aberration corrections for the holographic image display system using the method of any preceding claim;
determining a hologram for the displayed image, corrected using said mapped phase aberration corrections; and
displaying said corrected hologram of said image on an spatial light modulator (SLM) of the holographic image display system to display said image holographically.

15. A holographic image display system configured for use in the method of claim 14, the holographic image display system comprising:
a spatial light modulator (SLM) to display a hologram;
at least one coherent light source configured to illuminate said SLM;
projection optics to project an image formed by said illuminated, displayed hologram onto an image plane; and
a processor having an output for driving said SLM with hologram data to display a said wavefront sensing hologram.

16. A holographic image display system as claimed in claim 15 including storage for storing aberration correction data for said map of phase aberration corrections, and wherein said processor is configured to apply said map of phase aberration corrections to said wavefront sensing hologram for display on said SLM.

17. A holographic image display system as claimed in claim 16 wherein said processor is configured to calculate corrected hologram data, gᵤᵥ^{c}, for said displayed hologram from uncorrected hologram data, gᵤᵥ, using said map of phase aberrations from gᵤᵥ^{c}=exp (iΨ) gᵤᵥ where W=exp(iΨ) represents a complex conjugate of an aberration field defined by said map of phase aberration corrections.

18. A holographic image display system as claimed in claim 15 comprising:
means for displaying a wavefront sensing hologram on said SLM, said wavefront sensing hologram comprising a hologram having first and second spatial portions on said SLM, said first spatial portion comprising a patch of said hologram configured to direct light towards a target spot position in said image plane, said second spatial portion comprising a remainder of said hologram apart from said first spatial portion, said second spatial portion of said hologram being configured to direct light away from said target spot position in said image plane.

19. A holographic image display system as claimed in claim 18 further comprising one or more of:
means for measuring a position of a spot in said image plane formed by illuminating said wavefront sensing hologram with said coherent light source;
means for determining a gradient of a phase aberration correction for said holographic image display system, to be applied at a position of said patch on said SLM, from a difference between said measured position of said spot and said target spot position;
means for repeating said displaying, measuring and determining for a plurality of different said wavefront sensing holograms having a plurality of different spatial positions of said patch; and
means for using said determined gradients of phase aberration correction to map phase aberration corrections for said holographic image display system.

20. A holographic image display system corrected for optical aberrations, the system comprising:
a spatial light modulator (SLM) to display a hologram;
at least one coherent light source configured to illuminate said SLM;
projection optics to project a holographically generated two-dimensional image, said projection optics being configured to form, at an intermediate image surface, an intermediate two-dimensional image corresponding to said holographically generated image;
a diffuser located at said intermediate image surface;
a processor having an output for driving said SLM with hologram data to display an image; and
non-volatile memory storing a map of phase aberration corrections to be applied to said hologram displayed by said SLM when projecting said image to correct for optical aberrations of said holographic image display system.

21. A holographic image display system as claimed in claim 20 wherein said processor is configured to calculate corrected said hologram data, gᵤᵥ^{c}, for driving said SLM to display said image from uncorrected said hologram data, gᵤᵥ, using said map of phase aberrations, from gᵤᵥ^{c}=exp (iΨ) gᵤᵥ where W=exp(iΨ) represents a complex conjugate of an aberration field defined by said map of phase aberration corrections.

22. A holographic image display system corrected for aberrations determined using the method any one of claim 1.

23. A physical carrier carrying processor control code for determining an aberration correction using the method of claim 1, the processor control code comprising code for:
displaying said wavefront sensing hologram on said SLM;
capturing an image from a camera;
measuring a position of a spot in said image plane formed by said wavefront sensing hologram;
determining a gradient of a phase aberration correction for said holographic image display system, to be applied at a position of said patch on said SLM, from a difference between said measured position of said spot and said target spot position of said wavefront sensing hologram;
repeating said displaying, capturing, measuring and determining for a plurality of different said wavefront sensing holograms having a plurality of different spatial positions of said patch; and
using said determined gradients of phase aberration correction to map phase aberration corrections for said holographic image display system.

24. A method of determining an aberration correction for the holographic image display system of claim 20, the method comprising:
displaying a wavefront sensing hologram using said holographic image display system, said wavefront sensing hologram comprising at least one patch configured to direct light towards a target spot position in an image plane of said holographic image display system;
measuring a position of a spot in said image plane formed by said holographic image display system;
determining a gradient of a phase aberration correction for said holographic image display system to be applied at a position of said patch on said hologram from a difference between said measured position of said spot and said target spot position;
repeating said displaying, measuring and determining for a plurality of different said wavefront sensing holograms having a plurality of different spatial positions of said patch; and
using said determined gradients of phase aberration correction to map phase aberration corrections for said holographic image display system.
